(19) United States
(12) Patent Application Publication
(10) Pub. No.: US 2019/0168306 A1
(43) Pub. Date: Jun. 6, 2019

(54) Cam follower roller device, notably for a fuel injection pump

(71) Applicant: Aktiebolaget SKF, Gothenburg (SE)

(72) Inventors: Samuel Viault, Saint-Antoine-du-Rocher (FR); Charles Chambonneau, Ballan Miré (FR); Thomas Perrotin, Saint Roch (FR)

(21) Appl. No.: 16/120,701

(22) Filed: Sep. 4, 2018

(30) Foreign Application Priority Data
Dec. 6, 2017 (DE) 102017221996.3

(51) Int. Cl. B22F 5/00; B22F 1/00; F16H 53/06; F01L 1/14; F02M 59/10

(52) U.S. Cl. CPC B22F 5/008; B22F 1/0059; F16H 53/06; F01L 1/143; B22F 2301/35; F01L 2105/02; F01L 2107/00; F01L 2103/00; F02M 59/102

(57) ABSTRACT

A cam follower roller device comprising a tappet body extending along a longitudinal axis and defining a tappet bore, and a bearing assembly mounted in the tappet bore. The bearing assembly includes a pin centered on a pin transverse axis (the transverse axis is perpendicular to the longitudinal axis), and a roller rotatably mounted on the pin. The tappet body is made by a metal injection molding process including successive steps of mixing a metal powder with a thermoplastic binder, forming a part by injection of the mixed powder in a closed die, debinding the formed part in a furnace, sintering to densify the part, and quenching to set a tappet body hardness, to improve wear resistance and fatigue life.

### CROSS-REFERENCE

This application claims priority to German patent application no. 102017221996.3 filed on Dec. 6, 2017, the contents of which are fully incorporated herein by reference.

### TECHNOLOGICAL FIELD

The present invention relates to a cam follower roller device for actuating a reciprocating movement used in automotive or industrial applications.

One advantageous application of the invention is the use of the cam follower roller device in a fuel injection pump intended for an internal combustion engine, notably of a motor vehicle. Another advantageous application of the invention is the use of the device in a rocker system intended for controlling valves of an internal combustion piston engine.

### BACKGROUND OF THE PRESENT INVENTION

A cam follower roller device generally comprises an outer tappet body, a roller and a pin in bronze or steel. The roller is rotatably mounted on the pin so as to form a rolling assembly centered on a transverse axis, while the tappet extends along a longitudinal axis. Needles or a bushing may be longitudinally interposed between the roller and pin to ensure roller in rotation relative to the pin around its axis, or pin outer surface may be specifically coated to support direct rotation of roller. The tappet is formed with a cylindrical body delimiting an internal volume wherein are arranged the rolling assembly.

The roller axially extends from the tappet so as to collaborate with a cam synchronized with the internal combustion engine camshaft or crankshaft. The rotation of the camshaft or crankshaft leads to a periodic displacement of a piston of the pump that rests against the tappet, to allow fuel to be delivered. In operation, the tappet is intended to slide back and forth into a housing, such as a pump housing. Patent application US 2008/0190237 discloses such a conventional cam follower roller device.

The outer tappet body is generally made of forged metal, and then machined to provide its final shape and dimensions. The forged tappet body is suitable to support load applied to the cam follower roller device induced by pressure of the fuel pump. However, the manufacturing and material costs of the forged tappet body are expensive, and the forged tappet body is of relatively important weight. It desirable to reduce the cam follower roller device weight, hence the outer tappet body weight, so as to reduce fuel consumption. It is also desirable to use a manufacturing process less expensive and enabling complex shapes to the outer tappet body.

For this purpose, it has been proposed in EP 2 853 698 A1, for example, an outer tappet body made of synthetic material, notably of polyamide or polyether-ether-ketone. A tappet body in thermoplastic polymer material permits the combination of low manufacturing and material costs, low weight, and high shape complexity. Great precision and fine surface detail are now achieved. However, such material is structurally inferior to metallic material, and is not suitable as such to support loads in a fuel injection pump. In the example of EP 2 853 698 A1, stiffening inserts are additionally provided to the tappet body.

### BRIEF SUMMARY OF THE PRESENT INVENTION

The aim of the invention is to overcome these drawbacks by proposing a cam follower roller device suitable to support higher loads in fuel injection pump, and made by a process that permits shapes of high complexity.

To this end, the invention relates to a cam follower roller device comprising a tappet body extending along a longitudinal axis and defining a tappet bore, and a bearing assembly mounted in the tappet bore. The bearing assembly comprises a pin centered on a pin transverse axis being perpendicular to the longitudinal axis, and a roller rotatably mounted on the pin.

According to the invention, the tappet body is made by metal injection molding process including the successive steps of mixing a metal powder with a thermoplastic binder, forming a part by injection of the mixed powder in a closed die, debinding such a formed part in a furnace, sintering to densify the part, and quenching to set a tappet body hardness, to improve wear resistance and fatigue life.

Thanks to the invention, a tappet body of complex shape can be manufactured for use in a cam follower roller device. The metal injection molding process prevents the use of additional secondary machining, and also prevents waste. The tappet body surface is fine without additional refining process step.

The tappet body density can be defined as high as necessary during the sintering step, and is suitable for use in cam follower roller device application, and in particular in a fuel injection pump of a motor vehicle.

According to further aspects of the invention which are advantageous but not compulsory, such a cam follower roller device may incorporate one or several of the following features:

The tappet body comprises two transverse cylindrical through-holes transversally facing one another and receiving each an end of pin, the through-holes being provided to longitudinal portions of tappet body and forming support means for the pin.

The tappet body comprises a support body fast in tappet bore, the support body comprising a transverse base and two longitudinal flanges that are transversally opposed and that extend longitudinally from the base, each flange comprising support means for receiving an end of pin.

The tappet body comprises a rear abutment surface extending transversally between inner walls in tappet bore, the rear abutment surface being formed integral with tappet body.

The cam follower roller device comprises at least one anti-rotation device on an outer periphery of the tappet body.

Rolling elements are interposed between the pin and the roller.

The rolling elements are rollers or needles.

A bushing is interposed between the pin and the roller.

The metal powder is a steel alloy.

The metal powder is a steel alloy comprising nickel, chromium and molybdenum case hardening steel. Advantageously, the metal powder is the steel alloy 21NiCrMo2.

The metal powder is an alloy of steel comprising nickel, carbon and molybdenum case hardening steel. Advantageously, the metal powder is the steel alloy MIM-4605.

The limit of elasticity of tappet body is comprised between 1000 MPa and 1500 MPa.

The limit of elasticity of tappet body is advantageously substantially equal to 1200 MPa.

An ultimate tensile strength of the tappet body is between 1200 MPa and 1700 MPa.

The ultimate tensile strength of the tappet body is advantageously substantially equal to 1500 MPa.

The tappet body has a surface roughness of between 250 and 830 Hv. The tappet body surface roughness is advantageously superior to 650 Hv on the rear abutment surface.

The process further comprises finishing operations of tappet body surfaces.

The invention also concerns an injection pump for a motor vehicle, equipped with a cam follower roller device as mentioned here-above.

The invention also concerns a valve actuator for a motor vehicle, equipped with a cam follower roller device as mentioned here-above.

### BRIEF DESCRIPTION OF THE DRAWINGS

The invention will now be explained in correspondence with the annexed figures, as illustrative examples, without restricting the object of the invention. In the annexed figures:

FIG. 1 presents a perspective top view of a cam follower roller device;

FIG. 2 presents a sectional view along section line I-I of the cam follower roller device as shown in FIG. 3; and

FIG. 3 presents a sectional view along section line II-II of the cam follower roller device as shown in FIG. 2.

### DETAILED DESCRIPTION OF THE PRESENT INVENTION

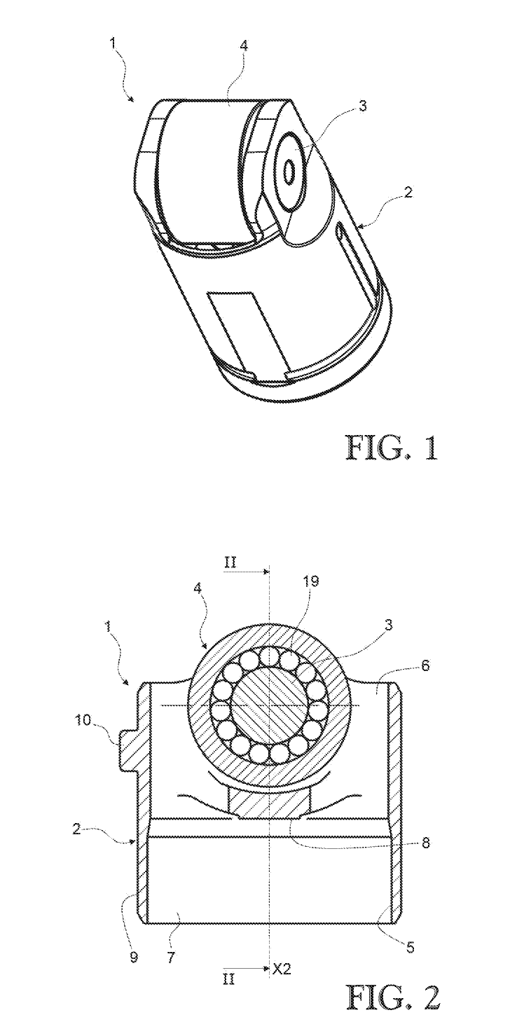

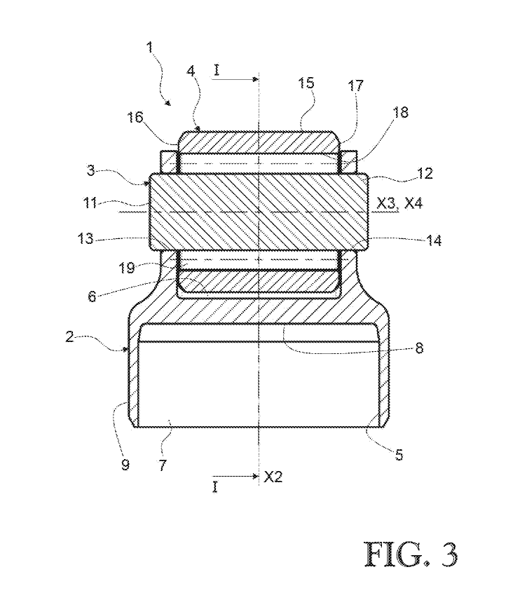

As shown in FIGS. 1 to 3, a cam follower roller device 1 includes a tappet housing or body 2 extending along a longitudinal axis X2, a shaft or pin 3 extending along a pin transverse axis X3, wherein the pin transverse axis X3 is perpendicular to the longitudinal axis X2, and a roller 4 mounted on the pin 3 and movable in rotation relative to the pin 3.

Hereinafter, to facilitate the special identification of the device 1 for these figures, the adjectives “longitudinal” and “transverse” and the adverbs “longitudinally” and “transversally” are defined relative to the axis X2 and X3, respectively. Thus a longitudinal portion or part is parallel to the longitudinal axis X2, whilst a transverse portion or part is perpendicular to the longitudinal axis X2 and parallel to the transverse axis X3.

In the disclosed example, the tappet body 2 is made in one part. The tappet body 2 delimits a tappet bore 5 with a first open cavity 6 inside which are located the pin 3 and the roller 4. The roller 4 longitudinally protrudes outwards with respect to an upper face of tappet body 2 and is dedicated to collaborate with a cam of an internal combustion engine (not shown). A tappet bore 5 defines a second open cavity 7 oriented axially on the side opposite to the first cavity 6. A movable element (not shown), such as a piston of a fuel injection pump, is intended to extend into cavity 7 and to axially bear against a rear abutment surface 8 of tappet body 2. The rear abutment surface 8 is oriented longitudinally on the side opposite to the roller 4. The rear abutment surface 8 is advantageously planar and extends transversally between inner walls in tappet bore 5, the rear abutment surface 8 longitudinally separating first and second open cavities 6, 7 being disposed on either side of the surface 8. Thanks to the tappet body manufacturing process as described below, the rear abutment surface 8 is made integral with tappet body 2.

The tappet body 2 is movable back and forth along the longitudinal axis X2, in a non-represented bore of a cylindrical housing belonging to the injection pump or motor with outer cylindrical surface 9 sliding in this bore. The surface 9 comprises anti-rotation means 10, here a protruding portion dedicated to slide in an adapted groove provided in the bore, to prevent any rotation of the tappet 2 in this bore.

The pin 3 is transversally cylindrical around the transverse axis X3. Pin 3 comprises two opposite pin ends 11, 12 and a central portion extending between the pin ends. The tappet body 2 further comprises two cylindrical through-holes 13, 14 provided to tappet longitudinal portions, made through the thickness of the tappet body 2 and open into the first open cavity 6. The cylindrical through-holes 13, 14 transversally face one another. The pin ends 11, 12 are mounted in the through-holes 13, 14, respectively. The pin ends 11, 12 are advantageously fastened to tappet body 2 for example by press-fitting, welding, gluing, caulking or by any other suitable means.

As an alternate not shown, a support body forming a support element for pin is provided in tappet bore. One example of such support body is illustrated in EP-A1-3 165 722. Basically, such support body comprises a transverse base and two longitudinal flanges that are transversally opposed and that extend longitudinally from the base, each flange comprising support means for receiving an end 11, 12 of pin 3.

The roller 4 comprises a cylindrical outer surface 15 which forms a contact surface intended to bear against the associated cam 6, two frontal end faces 16, 17 transversally delimiting the outer surface 15, and a central cylindrical bore 18. The roller 4 is centered on a roller transverse axis X4, which is common with pin transverse axis X3.

The roller 4 is rotatably mounted on the pin 3. As illustrated in FIG. 2, a plurality of rolling elements 19, here needles, is arranged between the central cylindrical bore 18 of the roller 3 and outer cylindrical surface of pin 3. Alternatively, a sliding bushing is arranged between the pin 3 and the roller 4 to support the roller rotation with respect to the pin.

According to the invention, the tappet body 2 is made by metal injection molding process that includes the successive following steps.

A metal powder and a thermoplastic binder are mixed together. Mixing coats the metal powder particles with the binder breaks up agglomerates and permits to obtain homogeneity of distribution of metal power particles and binder. Mixing is performed in any suitable mixing means, such as single or twin screw extruder, plunger extruder, double planetary mixer, twin cam mixer, for example. Advantageously, the metal powder is a steel alloy. According to a first embodiment, the metal powder is a steel alloy comprising nickel, chromium and molybdenum case hardening steel. Advantageously, the metal powder is the steel alloy 21NiCrMo2. According to another embodiment, the metal powder is an alloy of steel comprising nickel, carbon and molybdenum case hardening steel. Advantageously, the metal powder is the steel alloy MIM-4605.

A tappet body part is formed by injection of the mixed powder in a closed die. The mixed powder is progressively filled in a closed die, the die defining a hollow shape of the tappet body 2. The mixed powder fills the entire cavity without any void. The mixture of metal powder and binder being homogeneous, the metal powder and the binder are homogeneously distributed within the closed die. The mixed powder is filled in at pressure and temperature conditions suitable for the mixed powder composition. Furthermore, the temperature must be sufficient to the thermoplastic binder be aggregated with the metal power particles. The binder holds the metal particles together, but is unable to support stress, thermal gradients applied to a cam follower roller device in use in a fuel injection pump.

The thermoplastic binder is then removed from the tappet body material compound by debinding the formed part in a furnace. The debinding at high temperature is the preferred process instead of using solvent extraction processes. Indeed, the debinding by solvent extraction requires the immersion of tappet body 2 in a fluid that dissolves the thermoplastic binder, and has the disadvantage for the present final application to leave an open-pore structure. On the contrary, the debinding in a furnace extracts the thermoplastic binder from the pores as a fluid, the thermoplastic binder passing to a liquid and/or vapor state under the effect of high temperature.

This debinding step is combined/followed by sintering the tappet body 2, the metal particles being heated and soldering to each other, also under the effect of high temperature. The homogeneity of the mixed powder during the mixing step and then the injecting step leads to a homogeneous sintered structure of tappet body material and at an acceptable density for the application in a fuel injection pump, with controlled dimensions and properties. The exemplary embodiment of steel alloys 21NiCrMo2 and MIM-4605 permits to reach the desired tappet body characteristics.

The limit of elasticity of tappet body is comprised between 1000 MPa and 1500 MPa, and advantageously substantially equal to 1200 MPa.

The ultimate tensile strength of the tappet body is comprised between 1200 MPa and 1700 MPa, and advantageously substantially equal to 1500 MPa.

The tappet body 2 is then quenched to set a tappet body hardness, to improve wear resistance and fatigue life.

Advantageously, the process may further comprise finishing operations on the tappet body surfaces.

The tappet body 2 is of surface roughness comprised between 250 and 830 Hv. Advantageously, the surface roughness on the rear abutment surface 8 is superior to 650 Hv since this part is in direct contact with a plunger and has to support high loads.

The present invention has been illustrated on the basis of a cam follower roller device which can for example be used in a fuel injection pump intended for an internal combustion engine. It is also possible, without departing from the scope of the invention, to provide a cam follower roller device in a rocker system which is used for the control of valves of an internal combustion engine.

Representative, non-limiting examples of the present invention were described above in details with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provided improved cam follower roller device.

Moreover, various features of the above-described representative examples, as well as the various independent and dependant claims below, may be combined in ways that are not specifically and explicitly enumerated in order to provide additional useful embodiments of the present teachings.

What is claimed is:

1. A method of manufacturing a cam follower roller device, the method comprising steps of:
obtaining a tappet body, the tappet body extending along a longitudinal axis, a tappet bore being formed along the longitudinal axis within the tappet body;
mounting a bearing assembly within the tappet bore, the bearing assembly comprising a pin centered on a pin transverse axis being perpendicular to the longitudinal axis, and a roller rotatably mounted on the pin,
fabricating the tappet body by a metal injection molding process including successive steps of:
mixing a metal powder with a thermoplastic binder,
forming a part by injection of the mixed powder in a closed die,
debinding such a formed part in a furnace,
sintering to densify the part, and
quenching to set a tappet body hardness, to improve wear resistance and fatigue life.

2. The method of manufacturing the cam follower roller device according to claim 1, wherein the tappet body further comprises two transverse cylindrical through-holes transversally facing one another and receiving each an end of pin, the through-holes being provided to longitudinal portions of tappet body and forming a support for the pin.

3. The method of manufacturing the cam follower roller device according to claim 1, wherein the device comprises at least one anti-rotation device located on an outer periphery of the tappet body.

4. The method of manufacturing the cam follower roller device according to claim 1, wherein the step of mixing a metal powder with a thermoplastic binder utilizes a steel alloy as the metal powder.

5. The method of manufacturing the cam follower roller device according to claim 4, wherein the step of mixing a metal powder with a thermoplastic binder utilizes an alloy of steel comprising nickel, carbon and molybdenum case hardening steel as the metal powder.

6. The method of manufacturing the cam follower roller device according to claim 1, wherein the step of mixing a metal powder with a thermoplastic binder utilizes a steel alloy comprising nickel, chromium, and molybdenum case hardening steel as the metal powder.

7. The method of manufacturing the cam follower roller device according to claim 1, wherein the obtained tappet body further comprises a rear abutment surface extending transversally between inner walls of the tappet bore, the rear abutment surface being formed integrally with the tappet body.

8. The method of manufacturing the cam follower roller device according to claim 7, wherein a surface roughness of the tappet body is advantageously superior to 650 Hv on the rear abutment surface.

9. The method of manufacturing the cam follower roller device according to claim 1, the method further comprising a step of installing the cam follower roller device into an injection pump for a motor vehicle.

10. The method of manufacturing the cam follower roller device according to claim 1, the method further comprising a step of installing the cam follower roller device into a valve actuator for a motor vehicle.
